(19) United States
(12) Patent Application Publication
(10) Pub. No.: US 2006/0238525 A1
(43) Pub. Date: Oct. 26, 2006

(54) Display apparatus, driving device and method thereof

(75) Inventors: Sung-Jin Hong, Seoul (KR); Cheol-Woo Park, Suwon-si (KR); Ung-Gyu Min, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/248,843

(22) Filed: Oct. 12, 2005

(30) Foreign Application Priority Data
Apr. 26, 2005 (KR) 2005-34608

(51) Int. Cl. G09G 5/00

(52) U.S. Cl. 345/204

(57) ABSTRACT

In a liquid crystal display (LCD) apparatus employing an impulsive driving method, a timing control part outputs a first control signal and a second control signal in response to a timing control signal. A data driving part provides a display panel with a first data signal in response to the first control signal during a first period and a second data signal in response to the first control signal during a second period. A gate driving part provides the display panel with a gate signal in response to the second control signal, the gate signal having a first gate pulse corresponding to the second period and a second gate pulse corresponding to the first period. The period in which the first gate pulse is applied is extended to a portion of the first period. Thus, a charging rate of the second data signal may be increased, so that the display quality of the LCD apparatus may be improved.

### CROSS-REFERENCE TO RELATED APPLICATION

This application claims priority to Korean Patent Application No. 2005-34608, filed on Apr. 26, 2005, the contents of which are herein incorporated by reference in its entirety.

### BACKGROUND OF THE INVENTION

1. Field of the Invention

The present invention relates to a display apparatus, a driving device thereof and a driving method thereof. More particularly, the present invention relates to a display apparatus capable of being efficiently operated using an impulsive type driving method, a driving device for the display apparatus and a method of driving the display apparatus.

2. Description of the Related Art

Viewing angle and response speed are important characteristics of a liquid crystal display (LCD) apparatus. Recently, LCD apparatuses are operated in an OCB mode to improve upon such characteristics. In OCB mode, the liquid crystal is initially in a homogenous (or planar) alignment state. When a predetermined voltage is applied to the liquid crystal, the liquid crystal transitions to a bend alignment state through a splay alignment state.

The OCB mode LCD apparatus has a wider viewing angle and faster response speed than a conventional LCD apparatus. An impulsive driving method is employed in the OCB mode LCD apparatus to display moving images.

In the impulsive type driving method, a data voltage is charged in the liquid crystal cell for an earlier ½ period of a one frame period, and a black data voltage is charged in the liquid crystal cell for a latter ½ period of the one frame period. A charging time of the data voltage is reduced by half in the impulsive driving method as compared to a conventional driving method, so that a charging rate of the data voltage decreases.

### SUMMARY OF THE INVENTION

Exemplary embodiments of the present invention provide a display apparatus capable of improving a charging rate of a data voltage, a driving device thereof and a driving method thereof.

In one aspect of the present invention, the display apparatus includes a display panel to display an image, a timing control part, a data driving part and a gate driving part. The timing control part outputs a first control signal and a second control signal in response to a timing control signal. The data driving part provides the display panel with a first data signal in response to the first control signal during a first period. The data driving part also provides the display panel with a second data signal in response to the first control signal during a second period. The gate driving part provides the display panel with a gate signal in response to the second control signal. The gate signal has a first gate pulse corresponding to the second period and a second gate pulse corresponding to the first period. The period in which the first gate pulse is applied is extended to a portion of the first period.

The first gate pulse controls the display panel to pre-charge the first data signal in the display panel during the portion of the first period and to charge the second data signal in the display panel for the second period.

The second gate pulse controls the display panel to charge the first data signal in the display panel.

The second control signal comprises at least two output enable signals, and each of the output enable signals comprises a first control period to control the first gate pulse and a second control period to control the second gate pulse.

The timing control part controls a time interval between the first control period and the second control period to change a ratio between a first period displaying an abnormal image within one frame and a second period displaying a normal image within the one frame.

The display panel comprises a liquid crystal display panel having two substrates and a liquid crystal layer between the two substrates, and the liquid crystal layer comprises a plurality of liquid crystal molecules operated in an optical compensated bend (OCB) mode.

In another aspect of the present invention, a driving device for a display apparatus having a display panel to display an image includes a timing control part, a data driving part and a gate driving part. The timing control part outputs a first control signal and a second control signal in response to a timing control signal. The data driving part provides the display panel with a first data signal in response to the first control signal during a first period. The data driving part also provides the display panel with a second data signal in response to the first control signal during a second period. The gate driving part provides the display panel with a gate signal in response to the second control signal. The gate signal has a first gate pulse corresponding to the second period and a second gate pulse corresponding to the first period. The period in which the first gate pulse is applied is extended to a portion of the first period.

In still another aspect of the present invention, a display apparatus includes a pixel part formed in an area that is defined by two gate lines adjacent to each other and two data lines adjacent to each other. According to a method of driving the display apparatus, a first data is charged in the pixel part during a first period. Then, a second data is charged in the pixel part during a second period after the first period. The first data is then charged in the pixel part during a third period after the second period.

### BRIEF DESCRIPTION OF THE DRAWINGS

The present invention will become more apparent to those of ordinary skill in the art when descriptions of exemplary embodiments thereof are read with reference to the accompanying drawings, of which:

FIG. 1 is a block diagram illustrating a liquid crystal display apparatus, according to an exemplary embodiment of the present invention.

FIG. 2 is a plan view illustrating a liquid crystal display panel of FIG. 1.

FIG. 3 is a cross-sectional view taken along a line I-I′ in FIG. 2.

FIG. 4 is a block diagram showing a timing control part of FIG. 1.

FIGS. 5A to 5H are timing diagrams illustrating a method of driving the liquid crystal display apparatus of FIG. 1.

FIGS. 6A to 6I are timing diagrams illustrating a method of driving the liquid crystal display apparatus, according to another exemplary embodiment of the present invention.

FIGS. 7A to 7C are timing diagrams illustrating various impulsive driving methods, according to exemplary embodiments of the present invention.

### DETAILED DESCRIPTION OF THE EXEMPLARY EMBODIMENTS

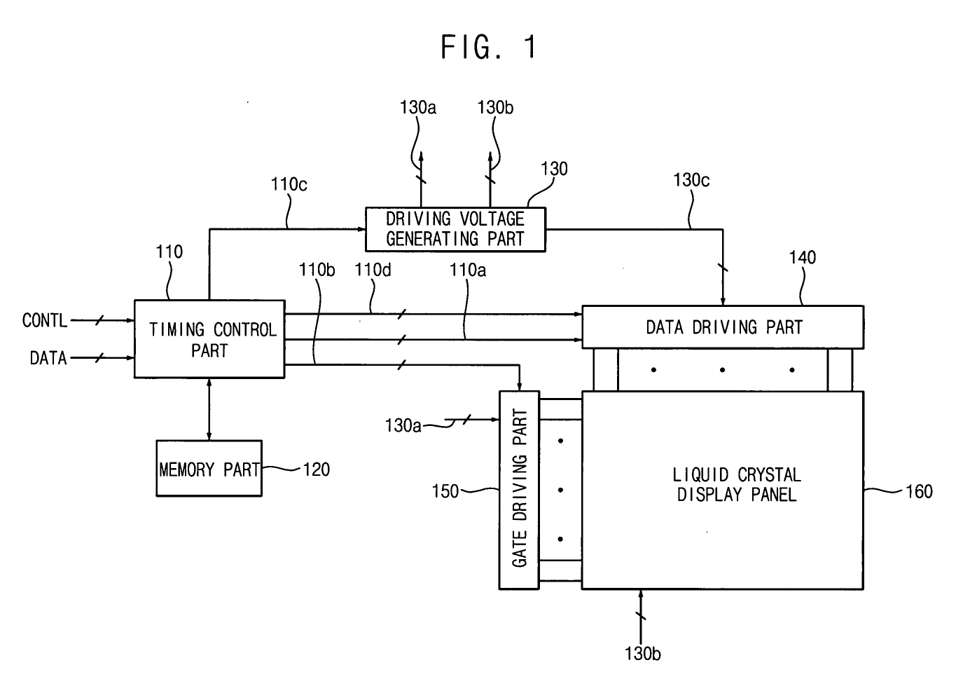

Hereinafter, the exemplary embodiments of the present invention will be described in detail with reference to the accompanying drawings. FIG. 1 is a block diagram illustrating a liquid crystal display apparatus, according to an exemplary embodiment of the present invention. Referring to FIG. 1, a liquid crystal display apparatus includes a timing control part 110, a memory part 120, a driving voltage generating part 130, a data driving part 140, a gate driving part 150 and a liquid crystal display panel 160.

The timing control part 110 receives a timing control signal CONTL corresponding to a first driving frequency generated by an external apparatus. The timing control part 110 generates a first control signal 110a, a second control signal 110b and a third control signal 110c corresponding to a second driving frequency in response to the timing control signal CONTL to control an operation of the liquid crystal display apparatus.

The first, second and third control signals 110a, 110b, 110c are applied to the data driving part 140, the gate driving part 150 and the driving voltage generating part 130, respectively, to control an operation of the data driving part 140, the gate driving part 150 and the driving voltage generation part 130, respectively.

In an embodiment of the present invention, the second control signal 110b includes at least two output enable signals OE to control an output of a gate signal. Each output enable signal OE has a first control period and a second control period that is shorter than the first control period. When the output enable signal OE is applied to the gate driving part 150, the gate driving part 150 outputs a first gate pulse of the gate signal during the first control period and outputs a second gate pulse of the gate signal during the second control period. The first and second control periods are s paced apart by a first time interval. The timing control part 110 controls the first time interval between the first and second control periods to change a ratio between a first period displaying a normal image within one frame and a second period displaying an abnormal image within the one frame.

The memory part 120 stores a predetermined portion of the input initial data DATA supplied from the external apparatus. For example, the memory part 120 can store one frame, one line or two lines of the input initial data DATA. The timing control part 110 stores the input initial data DATA corresponding to the first driving frequency in the memory part 120 and provides the data driving part 140 with the stored initial data 110d stored in the memory part 120 in response to the second driving frequency.

In an embodiment of the present invention, the second driving frequency is about two times that of the first driving frequency. For example, when the first driving frequency is about 60 Hz and the second driving frequency is about 120 Hz, one frame is about 16.7 ms.

In exemplary embodiments of the present invention, the data driving part 140 provides the liquid crystal panel 160 with a data voltage corresponding to an n-th initial data during an earlier ½ frame and provides the liquid crystal panel 160 with a black data voltage during a latter ½ frame. A ½ frame can be, for example, about 8.35 ms.

The driving voltage generating part 130 outputs a driving voltage to drive the liquid crystal display apparatus. As shown in FIG. 1, the driving voltage generating part 130 provides the gate driving part 150 with a plurality of gate voltages 130a and provides the liquid crystal panel 160 with a plurality of common voltages 130b. The driving voltage generating part 130 also provides the data driving part 140 with a plurality of reference gray-scale voltages 130c. The common voltages 130b include a common voltage supplied to a storage common line and a common voltage supplied to a common electrode of an opposite substrate.

The data driving part 140 converts the stored initial data 110d into the analog data voltage using the plurality of reference gray-scale voltages 130c and provides the liquid crystal panel 160 with the analog data voltage. The data driving part 140 provides a first data voltage of an n-th horizontal line to a plurality of data lines of the liquid crystal display panel 160 during the earlier ½H period (H is the repetitive period of the horizontal signal). The data driving part 140 also provides a second data voltage to the data lines of the liquid crystal display panel 160 during the latter ½H period. The second data voltage is generated by the data driving part 140 as the timing control part 110 controls the data driving part 140. The second data voltage is a data voltage of a lower gray-scale having a higher voltage level than the first data voltage in a normally white mode. For example, when an entire gray-scale level is divided into 256 gray-scales, the second data voltage has gray scales equal to or greater than 200 gray-scales. Preferably, the second data voltage has a black gray-scale or a gray gray-scale.

In accordance with embodiments of the present invention, a normal image is displayed on a screen of the liquid crystal display panel 160 for the earlier ½ period of one frame, and a black image is displayed on the screen of the liquid crystal display panel 160 for the latter ½ period of one frame.

As shown in FIG. 1, the gate driving part 150 receives a second control signal 110b from the timing control part 110 and the gate voltages 130a from the driving voltage generating part 130. The gate driving part 150 generates the gate signal in response to the second control signal 110b and the gate voltages 130a and provides the liquid crystal display panel 160 with the gate signal. The second control signal 110b includes at least two output enable signals OE (not shown).

The gate driving part 150 generates the gate signal having the first gate pulse and the second gate pulse using the two output enable signals OE. Particularly, the gate driving part 150 outputs the first gate pulse during the first control period of each output enable signal OE and outputs the second gate pulse during the second control period of each output enable signal OE.

The first gate pulse activates a predetermined horizontal line of the liquid crystal display panel 160 in response to the first data voltage, and the second gate pulse activates the predetermined horizontal line in response to the second data voltage.

A width of the first gate pulse W1 is larger than a width of the second gate pulse W2 and smaller than a 1H period. The width of the second gate pulse W2 is substantially identical with a ½H period. According to exemplary embodiments of the present invention, a period in which the first data voltage is applied to the horizontal line is extended to a period in which the second data voltage is applied to the horizontal line, enhancing a charging time of the first data voltage through a pre-charging method.

The liquid crystal display panel 160 includes a plurality of pixel portions P defined by a plurality of gate lines and a plurality of data lines. A switching device TFT, a liquid crystal capacitor (not shown) and a storage capacitor CST are formed in each of the pixel portions P.

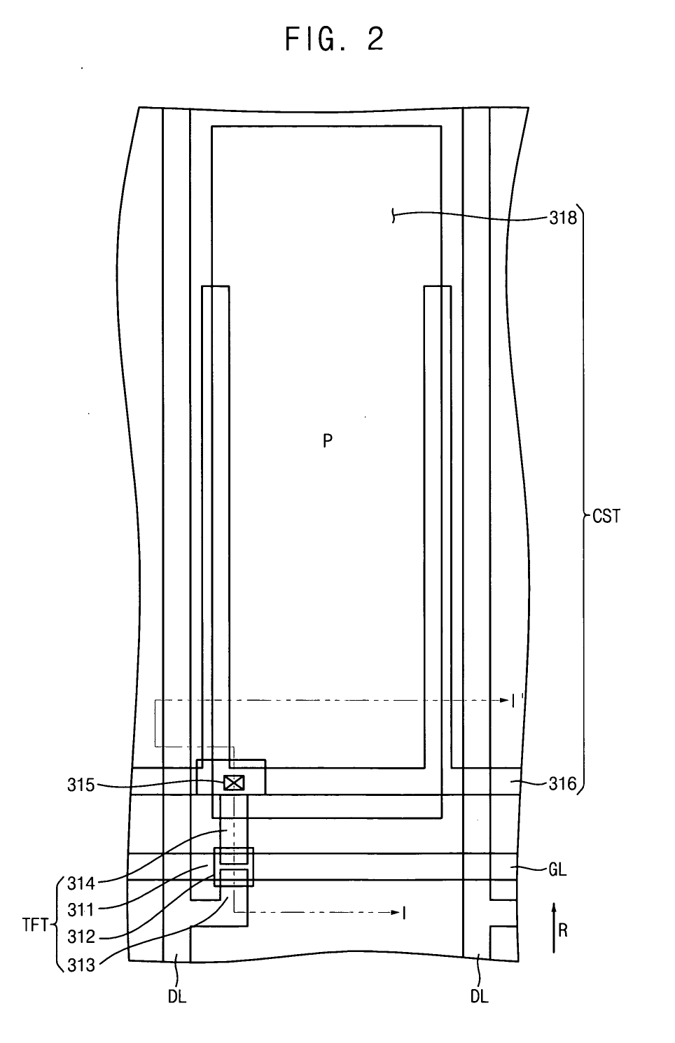

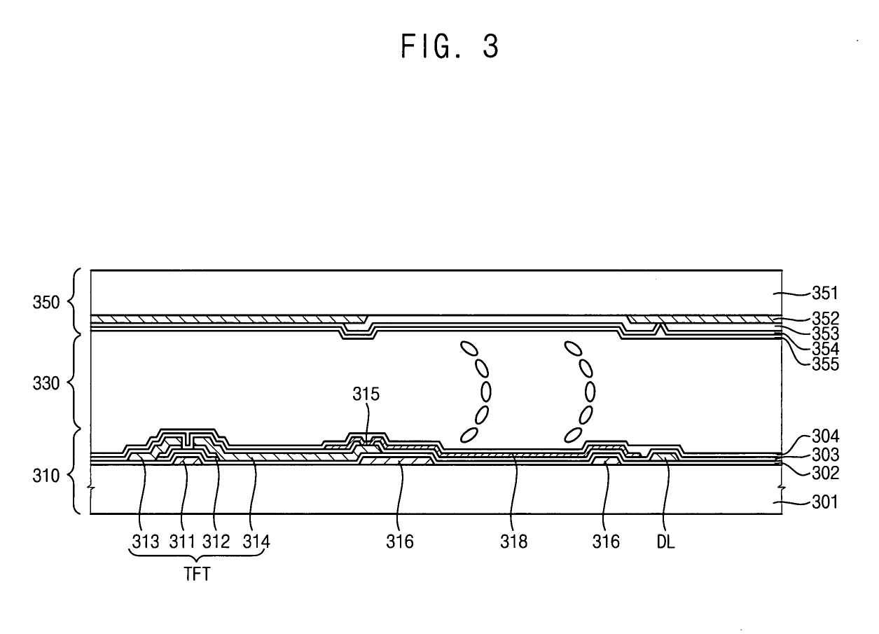

FIG. 2 is a plan view illustrating a liquid crystal display panel of FIG. 1. FIG. 3 is a cross-sectional view taken a long a line I-I′ in FIG. 2. The liquid crystal display panel of FIG. 2 is operated in an OCB mode.

Referring to FIGS. 2 and 3, the liquid crystal display panel includes an array substrate 310, a liquid crystal layer 330 and an opposite substrate 350. The array substrate 310 has a first base substrate 301, the data lines DL and the gate lines GL. The data lines DL and the gate lines GL are formed on the first base substrate 301 substantially orthogonal to each other. The pixel portions P are defined by the data lines DL and the gate lines GL. The switching device TFT, a storage common line 316 and a pixel electrode 318 are formed in each of the pixel portions P.

The switching device TFT includes a gate electrode 311, a source electrode 313 and a drain electrode 314. The gate electrode 311 is electrically connected to the gate line GL adjacent to the gate electrode 311, and the source electrode 313 is electrically connected to the data line DL adjacent to the source electrode 313. The drain electrode 314 is electrically connected to the pixel electrode 318. A gate insulating layer 302 and a channel layer 312 are formed between the gate electrode 311 and the source electrode 313 and between the gate electrode 311 and the drain electrode 314.

A passivation layer 303 covers the first base substrate 301 on which the switching device TFT is formed. The passivation layer 303 has a contact hole 315 through which the drain electrode 314 is exposed. The pixel electrode 318 is electrically connected to the drain electrode 314 via the contact hole 315.

The storage capacitor CST is defined by the storage common line 316 and the pixel electrode 318. The storage common line 316 is formed by patterning the same metal layer as the gate electrode 311 and the gate lines GL. A first alignment layer 304 is formed on the pixel electrode 318 and rubbed in a predetermined rubbing direction R.

The liquid crystal layer 330, in accordance with exemplary embodiments of the present invention, is aligned to allow the liquid crystal layer 330 to be operated in the OCB mode. The liquid crystal layer 330 includes nematic liquid crystal molecules that are aligned in a splay alignment during an initial period of time. The nematic liquid crystal molecules are aligned in a bend alignment while a predetermined voltage is applied to the liquid crystal layer 330. According to an exemplary embodiment of the present invention, liquid crystal layer 330 aligned in the bend alignment controls a light transmittance in response to a predetermined data voltage, so that the liquid crystal display panel 160 may display an image using the liquid crystal layer 330. For example, when the liquid crystal display panel 160 is operated in the normally white mode, the liquid crystal molecules are aligned in the bend alignment state during the initial period of time.

The opposite substrate 350 includes a second base substrate 351 and a light blocking pattern 352. The light blocking pattern 352 is formed on the second base substrate 351 so as to block a leakage of the light supplied to the light blocking pattern 352, and the light blocking pattern 352 defines a plurality of color areas. A plurality of color filter patterns 353 is formed in the color areas. Preferably, the color filter patterns 353 include a red color filter pattern, a green color filter pattern and a blue color filter pattern. A common electrode 354 is formed on the light blocking pattern 352 and the color filter patterns 353. As illustrated in FIG. 3, the common electrode 354 faces the pixel electrode 318.

A second alignment layer 355 is formed on the common electrode 354 and rubbed in a same direction as the alignment direction R of the first alignment layer 304.

In an embodiment of the present invention, the liquid crystal display panel 160 is operated in the OCB mode. Alternatively, the liquid crystal display panel 160 may be operated in a twisted nematic mode.

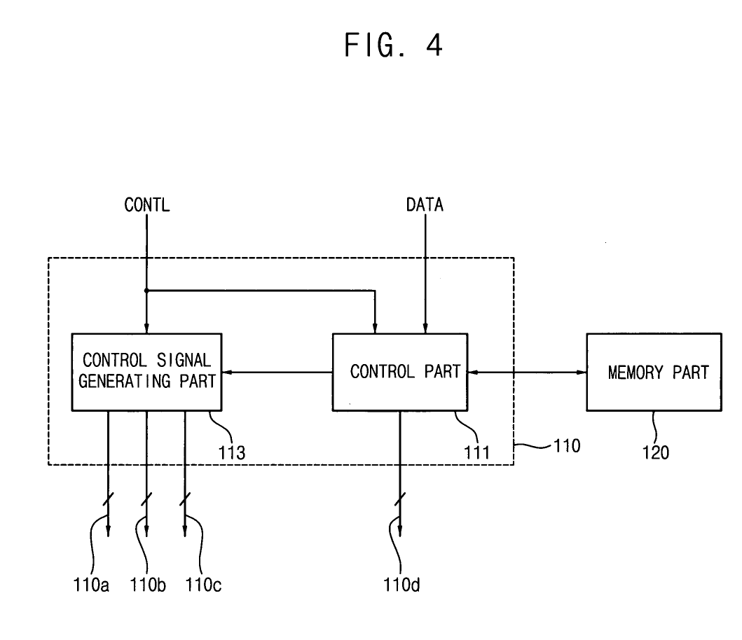

FIG. 4 is a block diagram showing a timing control part of FIG. 1. Referring to FIG. 4, the timing control part 110 includes a control part 111 and a control signal generating part 113.

The control part 111 writes the input initial data DATA into the memory part 120 and reads the stored initial data 110d from the memory part 120. In one embodiment of the present invention, the control part 111 writes the input initial data DATA supplied from the external apparatus into the memory part 120 in response to the first driving frequency and provides the data driving part 140 with the stored initial data 110d stored in the memory part 120 in response to the second driving frequency.

The control part 111 controls the control signal generating part 113. The control part 111 controls the control signal generating part 113 to generate the second driving frequency in response to the first driving frequency. In an embodiment of the invention, the first driving frequency is about 60 Hz, and the second driving frequency is about 120 Hz.

The control signal generating part 113 changes the timing control signal CONTL corresponding to the first driving frequency into the first, second and third control signals 110a, 110b and 110c corresponding to the second driving frequency in response to a signal from the control part 111.

The first control signal 110a is supplied to the data driving part 140, the second control signal 110b is supplied to the gate driving part 150 and the third control signal 110c is supplied to the driving voltage generating part 130.

The timing control signal CONTL includes a main clock signal, a horizontal synchronizing signal, a vertical synchronizing signal and a data enable signal.

The first control signal 110a includes a horizontal starting signal and a load signal. The data driving part 140 applies the first data voltage and the second data voltage to the liquid crystal display panel 160 in response to the load signal during the 1H period.

The second control signal 110b includes a scan starting signal, a scan clock signal and at least two output enable signals. Each output enable signal has the first control period to control the first gate pulse corresponding to the first data voltage and the second control period to control the second gate pulse corresponding to the second data voltage. The first control period is longer than that of the second control period. In accordance with an exemplary embodiment of the present invention, the first gate pulse has a width larger than the second gate pulse, so that a charging rate of the first data voltage may be increased. The third control signal 110c includes the main clock signal.

The first and second control periods are spaced apart by a first time interval. The timing control part 110 controls the first time interval between the first and second control periods to change a ratio between a first period displaying a normal image within one frame and a second period displaying an abnormal image within the one frame.

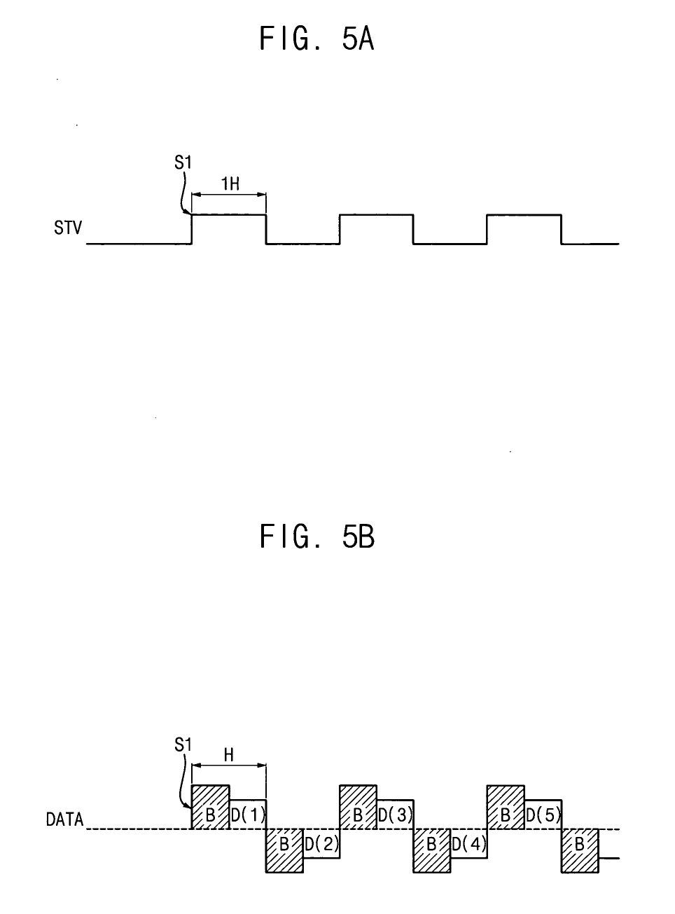

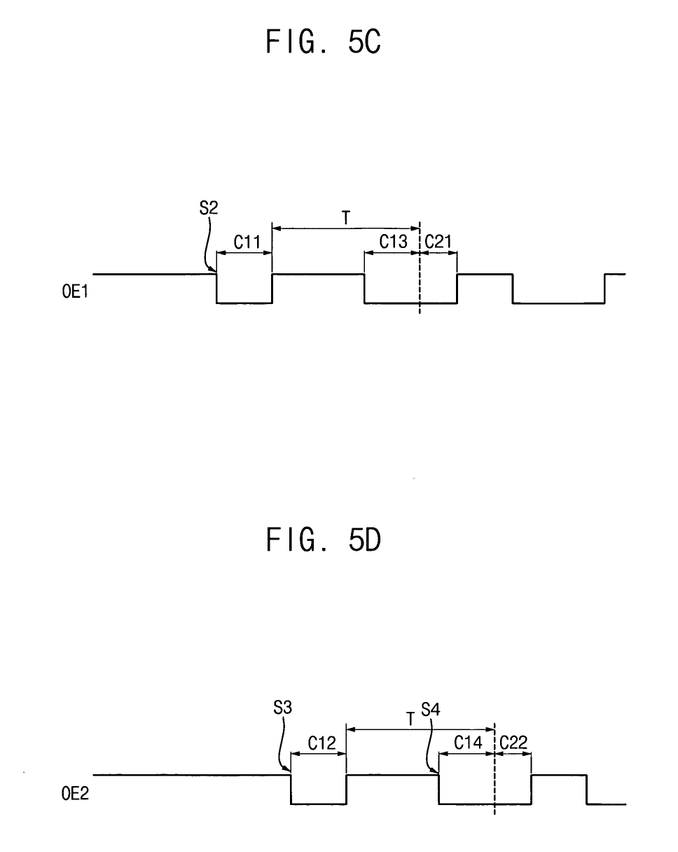

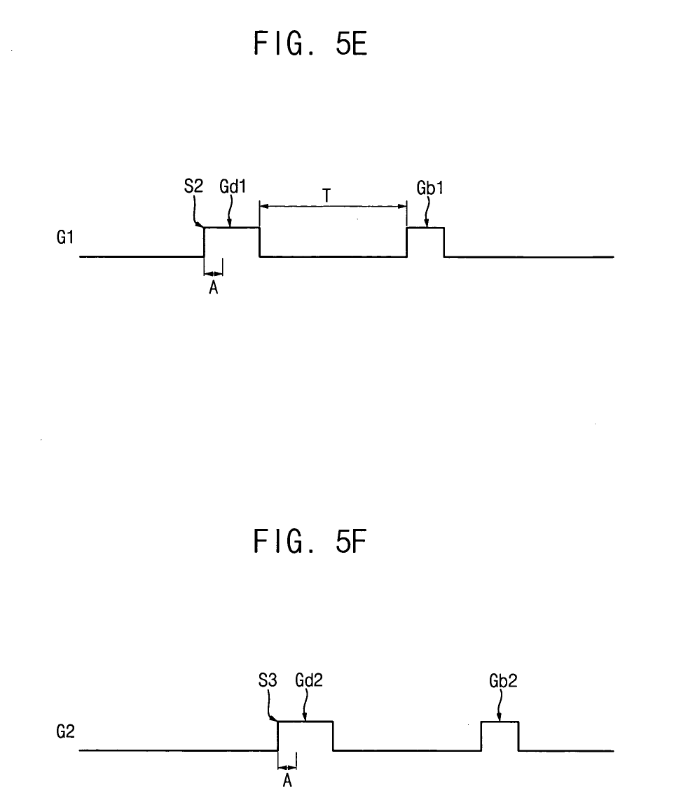

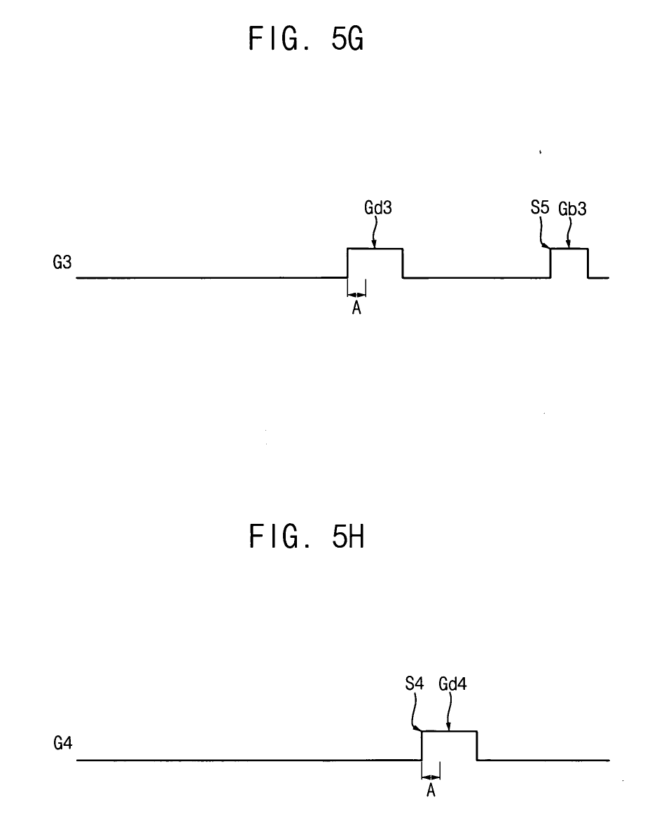

FIGS. 5A to 5H are timing diagrams illustrating a method of driving the liquid crystal display apparatus of FIG. 1. Referring to FIGS. 1, 5A, 5B, 5C and 5D, the timing control part 110 provides the gate driving part 150 with the second control signal 110b. The second control signal 110b includes the scan start signal STV, the first output enable signal OE1 and the second output enable signal OE2.

The first output enable signal OE1 controls an output of a plurality of odd-numbered gate signals G1, G3, . . . , G2K−1, and the second output enable signal OE2 controls an output of a plurality of even-numbered gate signals G2, G4, . . . , G2K. As shown in FIGS. 5C and 5D, each of the first and second output enable signals OE1 and OE2 includes the first control periods and the second control periods.

The first data voltages D(1), D(2), D(3) and D(4) shown in FIG. 5B are outputted from the data driving part 140 for the first control periods C11, C12, C13 and C14 shown in FIGS. 5C and 5D. As shown in FIGS. 5C to 5H, the respective first gate pulses Gd1, Gd2, Gd3 and Gd4 of the gate signals G1, G2, G3 and G4 are outputted from the gate driving part 150 in response to the first control periods C11, C12, C13 and C14, respectively.

The second data voltages B in FIG. 5B are outputted from the data driving part 140 for the second control periods C21 and C22 in FIGS. 5C and 5D. As shown in FIGS. 5C to 5H, the respective second gate pulses Gb1, Gb2, Gb3 and Gb4 (not shown) of the gate signals G1, G2, G3 and G4 are outputted from the gate driving part 150 in response to the second control periods C21 and C22.

As shown in FIGS. 5C and 5D, the first control periods C1, C12, C13 and C14 are longer than the second control periods C21 and C22. For example, the first control periods C11, C12, C13 and C14 each have a length in a range from a ½H period to a 1H period, and the second control periods is C21 and C22 each have a length substantially identical with the ½H period.

Referring to FIGS. 5C to 5H, the odd-numbered gate signals G1, G3, . . . , G2K−1 are outputted in response to the first output enable signal OE1. The first gate pulse Gd1 of a first gate signal G1 is outputted in response to a first one of the first control periods C11 of the first output enable signal OE1, and the first gate pulse Gd3 of a third gate signal G3 is outputted in response to a second one of the first control periods C13 of the first output enable signal OE1.

In addition, the first one of the first control periods C11 of the first output enable signal OE1 is spaced apart from a first one of the second control periods C21 of the first output enable signal OE1 by a first time interval T. The second gate pulse Gb1 of the first gate signal G1 is outputted in response to the first one of the second control periods C21 of the first output enable signal OE1.

On the other hand, the even-numbered gate signals G2, G4, . . . , G2K are outputted in response to the second output enable signal OE2. The first gate pulse Gd2 of a second gate signal G2 is outputted in response to the first one of the first control periods C12 of the second output enable signal OE2, and the first gate pulse Gd4 of a fourth gate signal G4 is outputted in response to the second one of the first control signal periods C14 of the second output enable signal OE2.

Also, the first one of the first control periods C12 of the second output enable signal OE2 is spaced apart from a first one of the second control periods C22 of the second output enable signal OE2 by the first time interval T. The second gate pulse Gb2 of the second gate signal G2 is outputted in response to the first one of the second control periods C22 of the second output enable signal OE2.

The first gate pulse Gd1 of the first gate signal G1 includes a latter portion A of a period where the second data voltage B is outputted from the data driving part 140. In accordance with embodiments of the present invention, the second data voltage is pre-charged in the horizontal line for the latter portion A of the period.

The first data voltage is charged in the first horizontal line in response to the first gate pulse Gd1 of the first gate signal G1. After the first time interval T, the second data voltage B is charged in the first horizontal line in response to the second gate pulse Gb1 of the first gate signal G1.

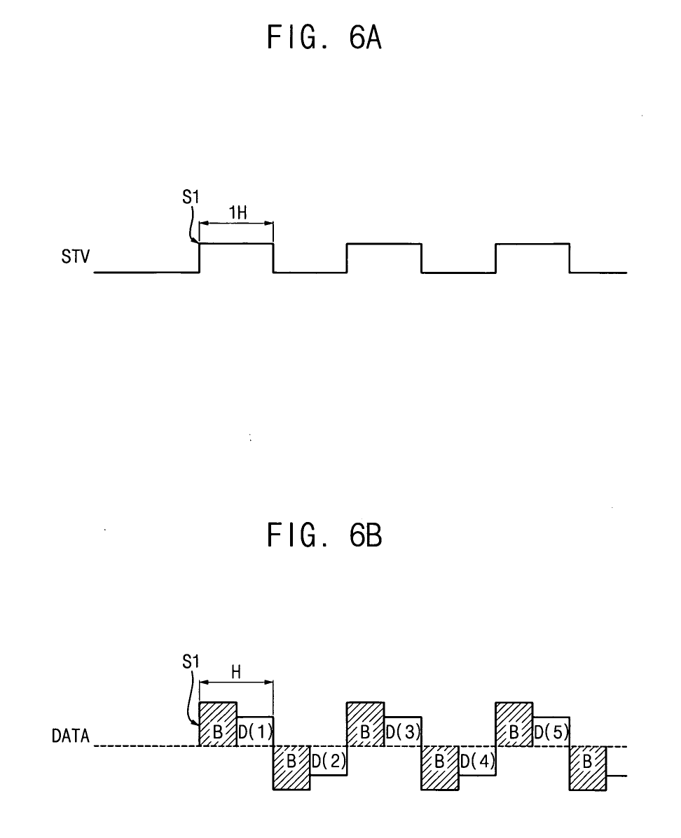

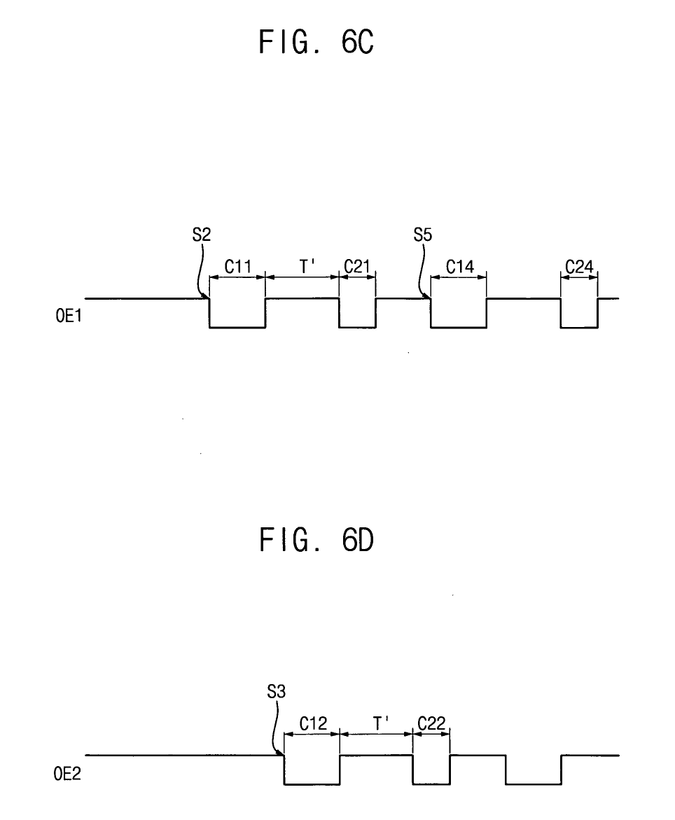

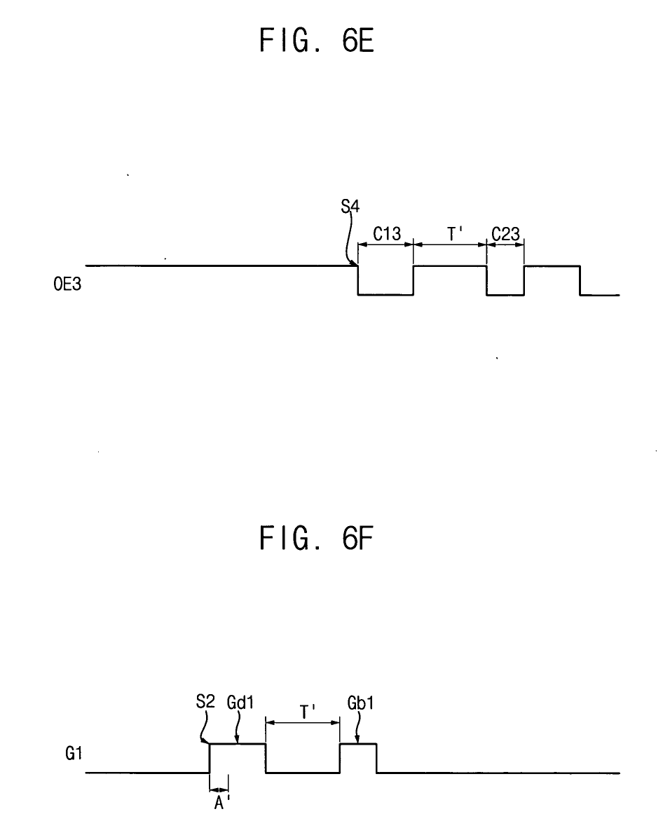

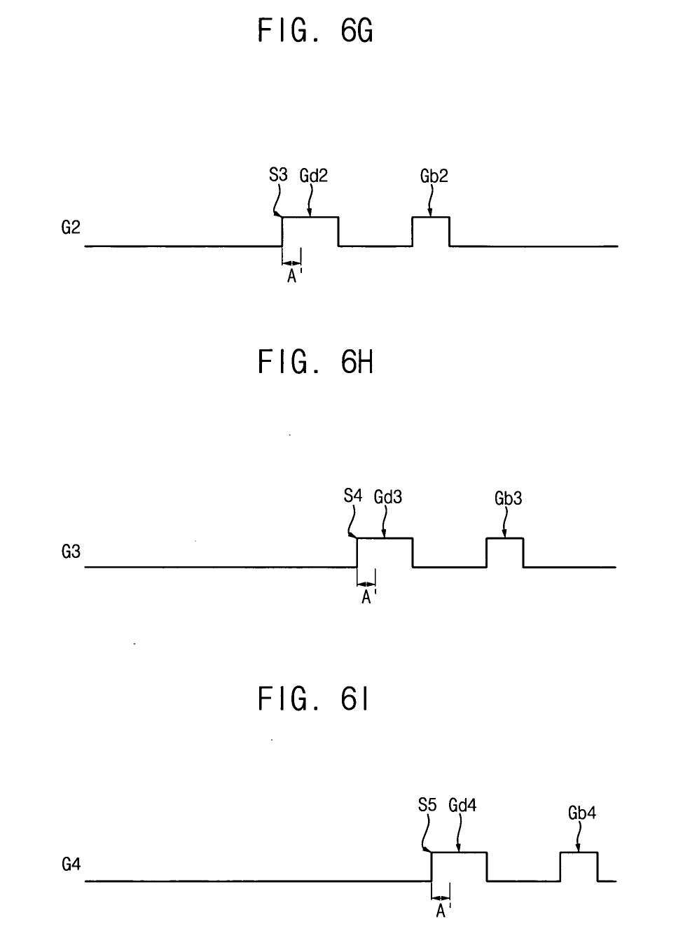

As described above, the first gate pulse Gd1 is extended to the latter portion A of the period where the second data voltage B is outputted. In accordance with embodiments of the present invention, the second data voltage is pre-charged in the horizontal line during the latter portion A of the period before the first data voltage is charged in the horizontal line, so that a charging rate of the first data voltage may be increased. When the liquid crystal display apparatus is operated in the impulsive method using a high frequency, the charging rate of the first data voltage may be improved. FIGS. 6A to 6I are timing diagrams illustrating a method of driving the liquid crystal display apparatus, according to another exemplary embodiment of the present invention. Referring to FIGS. 1 and 6A to 6E, the timing control part 110 provides the gate driving part 150 with the second control signal 110b.

The second control signal 110b includes the scan start signal STV, a first output enable signal OE1, a second output enable signal OE2 and a third output enable signal OE3. The first output enable signal OE1 controls an output of ‘3K−2’-th gate signals G1, G4, G7, . . . , G3K−2, the second output enable signal OE2 controls an output of ‘3K−1’-th gate signals G2, G5, G8, . . . , G3K−1, and the third output enable signal OE3 controls an output of ‘3K’-th gate signals G3, G6, G9, . . . , G3K, wherein the ‘K’ denote positive integers.

As shown in FIGS. 6B to 6D, each of the first, second and third output enable signals OE1, OE2 and OE3 includes the first control periods and the second control periods. The first data voltages D(l), D(2), D(3) and D(4) shown in FIG. 6B are outputted from the data driving part 140 during the first control periods C11, C12, C13 and C14, and the first control periods C11, C12, C13 and C 14 correspond to the respective first gate pulses Gd1, Gd2, Gd3 and Gd4 of the gate signals G1, G2, G3 and G4 shown in FIGS. 6F to 6I. The second data voltages B are outputted from the data driving part 140 during the second control periods C21, C22, C23 and C24. The second control periods C21, C22, C23 and C24 shown in FIGS. 6C to 6E correspond to the second gate pulses Gb1, Gb2, Gb3 and Gb4 of the gate signals G1, G2, G3 and G4 shown in FIGS. 6F to 6I.

The first control periods C11, C12, C13 and C14 are longer than the second control periods C21, C22, C23 and C24. In an embodiment of the present invention, the first control periods C11, C12, C13 and C14 have a length in a range from a ½H period to a 1H period, and the second control periods C21, C22, C23 and C24 have a length substantially identical with the ½H period.

Referring to FIGS. 6C to 6I, the first gate pulse Gd1 of the first gate signal G1 is outputted in response to the first one of the first control periods C11 of the first output enable signal OE1, and the first gate pulse Gd4 of the fourth gate signal G4 is outputted in response to the second one of the first control periods C14 of the first output enable signal OE1.

A first one of the first control periods C11 of the first output enable signal OE1 is spaced apart from a first one of the second control periods C21 of the first output enable signal OE1 by a second time interval T′. The second gate pulse Gb1 of the first gate signal G1 is outputted in response to the first one of the second control periods C21 of the first output enable signal OE1. Also, the second gate pulse Gb4 of the fourth gate signal G4 is outputted in response to a second one of second control periods C24 of the first output enable signal OE1.

The first gate pulse Gd2 of the second gate signal G2 is outputted in response to a first one of the first control periods C12 of the second output enable signal OE2. The first one of the first control periods C12 of the second output enable signal OE2 is spaced apart from a first one of the second control periods C22 of the second output enable signal OE2 by the second time interval T′. The second gate pulse Gb2 of the second gate signal G2 is outputted in response to the first one of the second control periods C22 of the second output enable signal OE2.

The first gate pulse Gd3 of the third gate signal G3 is outputted in response to a first one of the first control periods C13 of the third output enable signal OE3. The first one of the first control periods C13 of the third output enable signal OE3 is spaced apart from a first one of the second control periods C23 of the third output enable signal OE3 by the second time interval T′. The second gate pulse Gb3 of the third gate signal G3 is outputted in response to the first one of the second control periods C23 of the third output enable signal OE3.

The first gate pulse Gd1 of the first gate signal G1 includes a latter portion A′ of a period where the second data voltage B is outputted. According to an exemplary embodiment of the present invention, the second data voltage B is pre-charged in the horizontal line during the latter period A′ of the period.

A first one of the first data voltage D1 is charged in the first horizontal line in response to the first gate pulse Gd1 of the first gate signal G1. After the second time interval T′, the second data voltage B is charged in the first horizontal line in response to the second gate pulse Gb1 of the first gate signal G1.

As described above, the period in which the first gate pulse is applied is extended to the latter portion A′ of a period in which the second data voltage B is outputted. Thus, the second data voltage is pre-charged in the horizontal line during the latter portion of the period before the first data voltage is charged in the horizontal line, so that a charging rate of the first data voltage may be increased.

In accordance with exemplary embodiments of the present invention, when the liquid crystal display apparatus is operated in the impulsive method using a high frequency, the charging rate of the first data voltage may be improved.

In an embodiment of the present invention, the second control signal 110b includes two or three output enable signals. Alternatively, the second control signal 110b may include at least four output enable signals. The timing control part 110 controls the first time interval between the first and second control periods to change a ratio between a first period displaying a normal image within one frame and a second period displaying an abnormal image within the one frame.

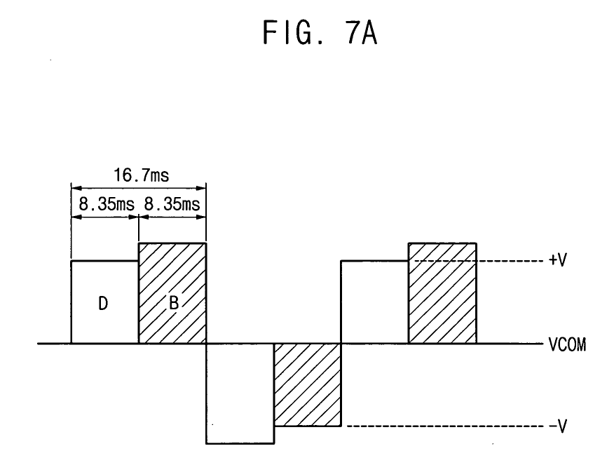

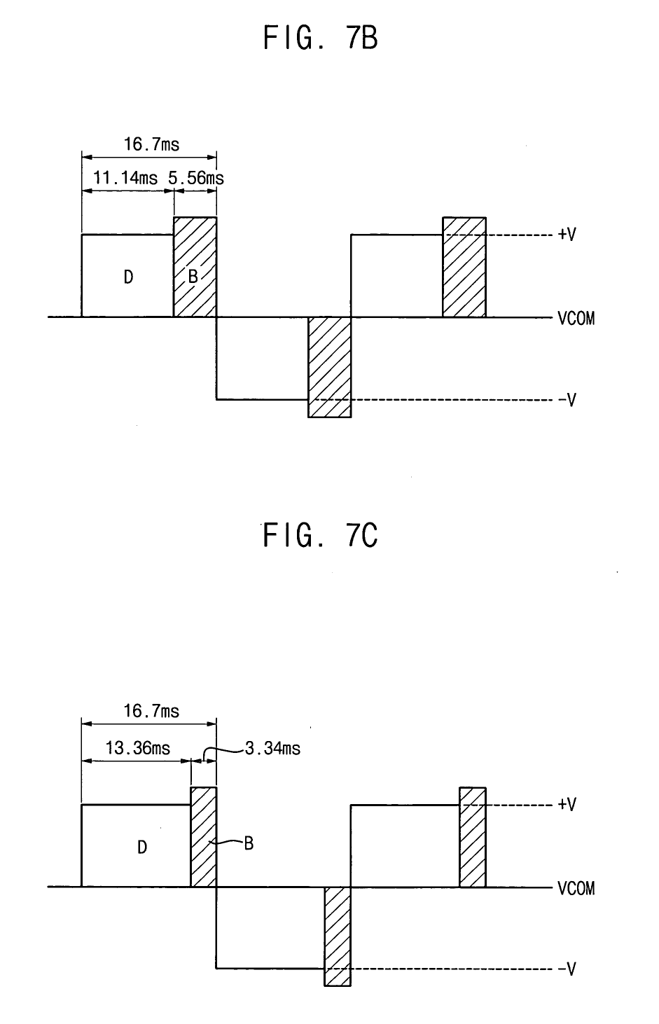

FIGS. 7A to 7C are timing diagrams illustrating various impulsive driving methods according to exemplary embodiments of the present invention. In the impulsive driving methods of FIGS. 7A to 7C, one frame is about 16.7 ms.

Referring to FIG. 7A, a time interval between the first control period and the second control period of the output enable signal is a ½ frame, and a time interval between the first gate pulse and the second gate pulse is a ½ frame. In FIG. 7A, a normal image is displayed for an earlier ½ frame, and a black image is displayed for a latter ½ frame. For example, the earlier ½ frame is about 8.35 ms, and the latter ½ frame is about 8.35 ms. The black image is displayed for the earlier ½ frame of a next frame, and the normal image is displayed for the latter ½ frame of the next frame.

In accordance with an embodiment of the present invention, a ratio between a first period displaying the normal image and a second period displaying the black image is 1:1.

Referring to FIG. 7B, the first time interval between the first control period and the second control period of the output enable signal is ⅔ of a frame, and the second time interval between the first gate pulse and the second gate pulse is ⅔ of a frame. In the impulsive driving method of FIG. 7B, a normal image is displayed for an earlier ⅔ of a frame, and a black image is displayed for a latter ⅓ of a frame. The earlier ⅔ of a frame is about 11.14 ms, and the latter ⅓ of a frame is about 5.56 ms. According to an embodiment of the present invention, a ratio between a first period displaying the normal image and a second period displaying the black image is 2:1.

Referring to FIG. 7C, the first time interval between the first control period and the second control period of the output enable signal is ⅘ of a frame, and the second time interval between the first gate pulse and the second gate pulse is ⅘ of a frame. In the impulsive driving method of FIG. 7C, a normal image is displayed for an earlier ⅘ of a frame, and a black image is displayed for a latter ⅕ of a frame. The earlier ⅘ of a frame is about 13.36 ms, and the latter ⅕ of a frame is about 3.34 ms.

As a result, a ratio between a first period displaying the normal image and a second period displaying the black image is 4:1.

As described above, an output of the first gate pulse and the second gate pulse of the gate signal may be controlled by a time interval between the first control period and the second control period of the output enable signal. In accordance with exemplary embodiments of the present invention, a ratio between a first period displaying the normal image and a second period displaying the black image may be controlled.

As described above, when the liquid crystal display apparatus is operated in the impulsive method using the high frequency, according to embodiments of the present invention, the output enable signal controlling the gate signal may be varied, thereby improving the charging rate of the data voltage. Thus, display quality of the liquid crystal display apparatus may be improved.

Although the processes and apparatus of the present invention have been described in detail with reference to the accompanying drawings for the purpose of illustration, it is to be understood that the inventive processes and apparatus are not to be construed as limited thereby. It will be readily apparent to those of reasonable skill in the art that various modifications to the foregoing exemplary embodiments may be made without departing from the scope of the invention as defined by the appended claims.

What is claimed is:

1. A display apparatus comprising:
a display panel;
a timing control part to output a first control signal and a second control signal in response to a timing control signal;
a data driving part to provide the display panel with a first data signal in response to the first control signal during a first period and a second data signal in response to the first control signal during a second period; and
a gate driving part to provide the display panel with a gate signal in response to the second control signal, the gate signal having a first gate pulse corresponding to the second period and a second gate pulse corresponding to the first period, the period in which the first gate pulse applied is extended to a portion of the first period.

2. The display apparatus of claim 1, wherein the first gate pulse controls the display panel to pre-charge the first data signal in the display panel during the portion of the first period and to charge the second data signal in the display panel for the second period.

3. The display apparatus of claim 1, wherein the second gate pulse controls the display panel to charge the first data signal in the display panel.

4. The display apparatus of claim 1, wherein the second control signal comprises at least two output enable signals.

5. The display apparatus of claim 4, wherein each of the output enable signals comprises a first control period to control the first gate pulse and a second control period to control the second gate pulse.

6. The display apparatus of claim 5, wherein the first control period is longer than the second control period and shorter than a 1H period.

7. The display apparatus of claim 5, wherein the timing control part controls a time interval between the first control period and the second control period to change a ratio between a first period displaying an abnormal image within one frame and a second period displaying a normal image within the one frame.

8. The display apparatus of claim 1, wherein the first data signal has a gray-scale lower than the second data signal.

9. The display apparatus of claim 1, wherein the first data signal has a black gray-scale.

10. The display apparatus of claim 1, wherein the display panel comprises a liquid crystal display panel having two substrates and a liquid crystal layer between the two substrates.

11. The display apparatus of claim 10, wherein the liquid crystal layer comprises a plurality of liquid crystal molecules operated in an optical compensated bend (OCB) mode.

12. The display apparatus of claim 10, wherein the display panel is operated in a normally white mode.

13. A driving device for a display apparatus comprising a display panel to display an image, the driving device comprising:
a timing control part to output a first control signal and a second control signal in response to a timing control signal;
a data driving part to provide the display panel with a first data signal in response to the first control signal during a first period and a second data signal in response to the first control signal during a second period; and
a gate driving part to provide the display panel with a gate signal in response to the second control signal, the gate signal having a first gate pulse corresponding to the second period and a second gate pulse corresponding to the first period, the period in which the first gate pulse is applied being extended to a portion of the first period.

14. The driving device of claim 13, wherein the second control signal comprises at least two output enable signals.

15. The driving device of claim 13, wherein each of the output enable signals comprises a first control period to control the first gate pulse and a second control period to control the second gate pulse.

16. A method of driving a display apparatus comprising a pixel part formed in an area that is defined by two gate lines adjacent to each other and two data lines adjacent to each other, the method comprising:
charging a first data in the pixel part during a first period;
charging a second data in the pixel part during a second period after the first period; and
charging the first data in the pixel part during a third period after the second period.

17. The method of claim 16, wherein the first period is shorter than a ½H period.

18. The method of claim 16, wherein the second period and the third period are substantially identical to the ½H period.

19. The method of claim 18, wherein a time difference between the second period and the third period is shorter than one frame.
